(19) United States
(12) Patent Application Publication
(10) Pub. No.: US 2004/0034583 A1
(43) Pub. Date: Feb. 19, 2004

(54) Systems and methods for performing electronic check commerce

(76) Inventors: Cheryl Lynn Lanier, Sugar Hill, GA (US); Michelle Rene Ellington, Tomball, TX (US); Michael Young, Highlands Ranch, CO (US); Jennifer Howard, Missouri City, TX (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/223,587

(22) Filed: Aug. 15, 2002

(51) Int. Cl. G06F 17/60

(52) U.S. Cl. 705/35; 705/39

(57) ABSTRACT

A secure and convenient electronic check transaction processing system that allows a customer and a merchant to agree on terms of a payment. A secure connection between the merchant and an independent entity such as a check acceptance service, preferably by a secure Internet connection, allows the customer and the merchant to set up a pre-approved schedule of payments by the customer to the merchant. The processing system provides a user-friendly interface that allows the user to easily set up the electronic payment schedule. The processing system also provides a back end process that carries out the scheduled payments and handles any returned payments.

### BACKGROUND OF THE INVENTION

1. Field of the Invention

This invention relates to processing of financial transactions and in particular, relates to processing of electronic check transactions by an independent entity separate from banks associated with merchants and their customers.

2. Description of the Related Art

Many financial transactions involve a merchant receiving a payment from a customer in exchange for a product or a service. And in many situations, the amount of payment can be relatively large enough such that the customer is unable or unwilling to pay at once. To accommodate such customers, some merchants offer an option that allows the payment to be made in installments. Such an option may be implemented in a variety of ways using the customer's checking account. For example, the customer may agree to make a series of payments over time by writing a separate check for each payment. Such a practice naturally adds an inconvenience to the customer, since due dates for each payment need to be honored. Alternatively, the customer may write and give to the merchant several post-dated checks, thereby allowing the customer to forget about the future due dates. Such a practice, however, simply shifts the inconvenience to the merchant by having the keep track of appropriate deposit dates of the post-dated checks. The situation can be exacerbated when the merchant has a plurality of such transactions involving post-dated checks.

To alleviate the inconvenience associated with keeping track of series of paper checks, some transactions are carried out such that specified amount of fund is automatically transferred from the customer's bank account to the merchant's bank account at specified intervals. Such a practice, however, is typically intended for long term transactions. For example, a membership payments to a health club may be made on a monthly basis via the automatic fund transfer. Activation of such a transaction typically requires a written authorization from the customer to be submitted to his or her bank, and the bank may require some time to set up the transaction. Many customers consider this practice to be an inconvenience. Furthermore, if the transaction between the customer and the merchant ceases (end of membership, for example), it is the customer's responsibility to make sure that merchant's access to his or her account also ceases. Without such an action by the customer, the merchant may continue to have access to his or her bank account even if the routine withdrawals have ceased. For these reasons, many customers are wary of the automatic fund transfer transactions.

Other forms of electronic check payment include services such as Bill Pay that allows a bank customer to electronically instruct the bank to make an electronic payment to a properly configured recipient. Such services are popular for bank customers who wish to make recurring monthly bill payments such as mortgage and utility payments. Because the bank and its customer have a business relationship, however, such systems are inherently geared towards the convenience of the bank customers. As such, merchants or service providers that receive the electronic payments generally do not gain benefits other than a more efficient form of processing payments that most likely would have been made anyway. That is, the bank sponsored electronic check payment system provides little or no benefit of improved commerce such as an increase in sales. Furthermore, the bank sponsored system requires that both the bank customer and the recipient be enrolled or subscribed to the service.

From the foregoing, there is a need for an improved system and method for performing a fund transfer between a customer and a merchant for one time purchase with flexible payment schedule. There is a need for an improved system and method for performing electronic check commerce.

### SUMMARY OF THE INVENTION

In one aspect, the aforementioned needs are satisfied by a system for processing an electronic check transaction between a merchant and its customer, wherein the system comprises a first connection that allows the merchant to connect to the system to arrange the electronic check transaction. The system further comprises a second connection that connects the system to an external fund transfer system thereby allowing funds to be transferred between the banks associated with the merchant and the customer. The system is independent from the banks. The system further comprises a risk assessment system that evaluates risks associated with the transaction and assigns a risk score. The system further comprises a processor that allows, based on the risk score, the merchant and a customer to electronically arrange the electronic check transaction via the first connection. The electronic check transaction comprises one or more predetermined number of electronic check payments at selected dates within a predetermined time limit. The processor executes the payments at the selected dates via the second connection.

In one embodiment, the system further comprises a merchant computer that connects to the processing system via the first connection. The system further comprises a merchant inventory database that interacts with the merchant computer and the processing system thereby allowing easier processing of product or service information by the processor. In one embodiment, the first connection comprises a secure Internet connection.

In one embodiment, the processor saves a transaction thereby allowing the merchant to modify or reverse the transaction at a later time. In one embodiment, the processor allows the merchant to have a hierarchy of authorized access to the system. The hierarchy of authorized access comprises a master account that is authorized to perform a first scope of functions associated with the merchant. The hierarchy of authorized access further comprises one or more sales accounts authorized to perform a second scope of functions that is less than the first scope of functions. The first scope of functions comprises substantially all of allowable functions associated with the merchant. The first scope of functions includes administration of the accounts wherein administration includes creation of new account and modification of existing accounts. In one embodiment, the second scope of functions comprises creating a new transaction.

In one embodiment, the second connection is configured to perform back end processes including a process for handling returned electronic payments. The process for handling the returns comprises processing the returned payment and any subsequent scheduled payments by paper draft if the return was due to an electronically non-resubmittable reason. The process for handling the returns further comprises submitting the payment for a second time if the return was due to reasons other than the non-resubmittable reason. The payment is processed by paper draft if the resubmitted payment is returned again.

In another aspect, the aforementioned needs are satisfied by a method of processing an electronic check transaction between a merchant and its customer. The method comprises establishing a first connection with the merchant and receiving details about the electronic check transaction. The method further comprises determining a risk associated with the electronic check transaction. The method further comprises allowing, based on the risk, the merchant and the customer to electronically arrange the electronic check transaction that comprises one or more predetermined number of electronic check payments at selected dates within a predetermined time limit. The method further comprises executing the arranged electronic check payments at the selected dates such that funds are transferred between the external banks associated the merchant and the customer.

In one implementation, establishing the first connection comprises forming a secure Internet connection with a merchant's computer. The method further comprises accessing merchant's inventory database to facilitate easier arrangement of the electronic check transaction. Allowing the merchant and the customer to arrange the electronic check transaction includes saving the transaction thereby allowing the merchant to modify or reverse the transaction at a later time. Establishing the first connection with the merchant comprises establishing a hierarchy of authorized access for one or more users of the merchant. Establishing the first connection with the merchant further comprises allowing a user to log in with designated authorized access. The designated authorized access allows the user to perform selected transaction related operations.

In one implementation, executing the arranged electronic check payments includes processing returned payments. Processing returned payments comprises routing the returned payment and any subsequent scheduled payments for collection by paper draft if the return was due to an electronically non-resubmittable reason. Processing returned payments further comprises submitting the payment electronically for a second time if the return was due to reasons other than the non-resubmittable reason. The payment is processed by paper draft for collection if the resubmitted payment is returned again.

In yet another aspect, the aforementioned needs are satisfied by an apparatus for processing an electronic check transaction between a merchant and its customer. The apparatus comprises a first means for establishing a connection with the merchant thereby allowing the merchant and the customer to request an electronic check transaction between the merchant and the customer. The transaction comprises one or more predetermined number of payments at selected dates that are within a predetermined time limit. The apparatus further comprises a second means for approving and executing the electronic check transaction between the banks associated with the merchant and the customer. The apparatus is independent from the banks.

In one embodiment, the first means for establishing the connection comprises establishing secure Internet connection with merchant's computer. The first means further comprises accessing merchant's inventory database to facilitate integration of product information into the electronic check transaction.

In one embodiment, the first means for establishing the connection includes a hierarchy of authorized access for different users at a given merchant establishment. The hierarchy determines the scope of allowed transaction related functions to be performed. Users of a high hierarchy is allowed to administer the accounts associated with users of hierarchy lower than or equal to the high hierarchy.

In one embodiment, the second means for approving and executing the electronic check transaction comprises a check approval system that evaluates risks associated with the transaction and either approves or declines the transaction. The second means further comprises a connection to an external fund transfer system. The external fund transfer system is instructed to carry out the pre-approved scheduled payments at the selected dates.

In one embodiment, the second means further comprises a process for handling returned payments. The process for handling returned payments comprises routing the returned payment and any subsequent scheduled payments for collection by paper draft if the return was due to an electronically non-resubmittable reason. The process for handling returned payments further comprises submitting the payment electronically for a second time if the return was due to reasons other than the non-resubmittable reason. The payment is processed by paper draft for collection if the resubmitted payment is returned again.

In yet another aspect, the aforementioned needs are satisfied by a system for processing a proffered electronic check transaction between a merchant and a customer. The proffered electronic check transaction comprises a plurality of separate promissory payments made from the customer's bank account to the merchant's bank account over a preselected period of time. The system comprises at least one point of sale device located in at least one merchant location. The at least one point of sale device transmits transaction information identifying the customer, the merchant, a proffered payment and a proffered payment schedule. The system further comprises a risk assessment agency that receives the transaction information and performs a risk assessment of the proffered payment and the proffered payment schedule to assess the likelihood that the customer will be able to provide the proffered payments at the proffered payment schedule. The system further comprises a bank transaction component associated with the risk assessment agency. The bank transaction component in response to the risk assessment agency determining that the customer has an acceptable risk level and accepts the proffered payment at the proffered payment schedule, interacts with the customer's and merchant's banks so that electronic checks will be forwarded from the customer's account to the merchant's account according to the proffered payment schedule.

In one embodiment, the at comprises a computer configured for a secure Internet connection. In one embodiment, the at least one point of sale device further comprises an inventory database at the merchant location and connected to the computer so as to facilitate the transaction information.

In one embodiment, the proffered payment schedule comprises a total amount to be paid divided into more than one individual payments at selected dates within a specified time limit such that the payment schedule is close ended. The risk assessment agency performs the risk assessment based on the total amount to be paid and either approves or declines the transaction based on the total amount.

In one embodiment, the bank transaction component further comprises a process configured to handle returned payments. The process comprises routing the returned payment and any subsequent scheduled payments for collection by paper draft if the return was due to an electronically non-resubmittable reason. The process further comprises submitting the payment electronically for a second time if the return was due to reasons other than the non-resubmittable reason. The payment is processed by paper draft for collection if the resubmitted payment is returned again.

In yet another aspect, the aforementioned needs are satisfied by a method of facilitating a purchase transaction by a customer from a merchant. The customer presents the merchant with an offer to purchase or good or service with a plurality of promissory payments made according to a pre-selected schedule. The method comprises transmitting information to a risk assessment component which evaluates whether the customer will be able to make the plurality of promissory payments according to the pre-selected schedule. The method further comprises transmitting a request from the risk assessment component to the customer's bank to establish a schedule of electronic check payments from the customer's bank account to the merchant's bank account which corresponds to the plurality of promissory payments made according to the pre-selected schedule.

In one implementation, transmitting information to the risk assessment component comprises transmitting information about the customer, the merchant, and the good or service being purchased. In one implementation, transmitting information further comprises obtaining information about the good or service being purchased directly from a database at the merchant location.

In one implementation, the schedule of electronic check payments comprises a total amount to be paid divided into more than one individual payments at selected dates within a specified time limit such that the payment schedule is close ended.

In one implementation, the method further comprises processing returned electronic check payments wherein a returned payment is processed via a paper draft if the returned payment meets a selected criteria.

### BRIEF DESCRIPTION OF THE DRAWINGS

FIG. 1 illustrates a schematic diagram that depicts a fund transfer process associated with an electronic check commerce;

FIG. 2 illustrates one embodiment of a check acceptance service having an electronic check commerce processing system interacting with a merchant and an external fund transfer system;

FIG. 3 illustrates one possible process for performing electronic check commerce with a merchant;

FIG. 4A illustrates one possible process for establishing a new account for a merchant;

FIG. 4B illustrates an exemplary merchant account access hierarchy;

FIG. 4C illustrates a generalized process for administrating of user accounts;

FIG. 4D illustrates a process for creating a new user account;

FIG. 4E illustrates a process for administering an existing account;

FIG. 5A illustrates one possible process for creating a new electronic check commerce transaction;

FIG. 5B illustrates one possible process for editing an existing transaction;

FIG. 5C illustrates one possible process for processing incomplete transactions;

FIG. 5D illustrates one possible process for transaction termination or reversal;

FIG. 6 illustrates one embodiment of the electronic check commerce processing system that incorporates an inventory database;

FIG. 7 illustrates one possible fund transfer scheduling scheme that executes a plurality of electronic check commerce transactions;

FIG. 8A illustrates one possible generalized process for effecting scheduled electronic fund transfers (EFTs);

FIG. 8B illustrates one possible process for handling returned EFTs;

FIGS. 9A and 9B illustrate an exemplary merchant configured to perform electronic check commerce transactions; and

FIGS. 10A-10I illustrate an exemplary transaction being performed by the exemplary merchant of FIG. 9.

### DETAILED DESCRIPTION OF THE PREFERRED EMBODIMENT

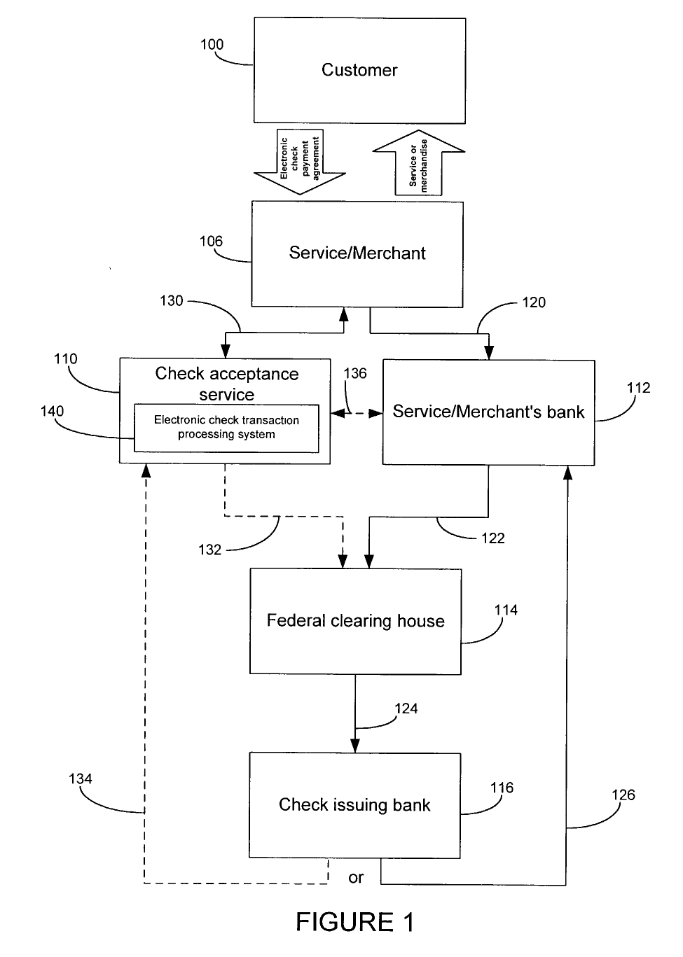

Reference will now be made to the drawings wherein like numerals refer to like parts throughout. FIG. 1 illustrates a block diagram of a typical financial transaction involving a check. A customer 100 makes a check payment to a service/merchant 106 (referred to as merchant hereinafter) in exchange for a service/merchandise 104 (referred to as merchandise hereinafter). A conventional paper check may be accepted and deposited into a merchant's bank 112 without receiving any external authorization as indicated by path 120. Such a check goes through a known clearing process, wherein the merchant's bank 112 sends the check to a federal clearing house 114 as indicated by path 122. The federal clearing house 114, in turn, sends the check to the check issuing bank 116 as indicated by path 124. If the check is considered to be valid, the check “clears” and the check's amount is debited from the checking account in the customer's bank 116 and is then transferred to the merchant's bank 112, as indicated by path 126 to complete the transaction successfully.

Alternatively, many merchants subscribe to and rely on a check acceptance service 110 to manage risks associated with accepting checks from customers. The interaction between the merchant 106 and the check acceptance service 110 is indicated by path 130. The check acceptance service 110 may provide various services, ranging from informing the merchant 106 to either accept or decline the customer's check based on assessed risk, to purchasing the check from the merchant 106 thereby fully assuming the risk (again based on assessed risk). If the check is purchased by the check acceptance service 110, the fund associated with the check may be collected directly electronically from the merchant's bank 112, as indicated by path 136. Alternatively, the check is sent from the check acceptance service 110 to the federal clearing house 114 as indicated by path 132. The check is then sent to the check issuing bank 116 as indicated by the path 124. If the check is valid, funds are transferred from the check issuing bank 116 to the check acceptance service 110 as indicated by path 134, and the transaction is completed for the check acceptance service 110.

As illustrated in FIG. 1, the check acceptance service 110 comprises an electronic check transaction processing system 140 that permits the customer 100 to make one or more electronic check payments at selected times in a manner described below. Such a feature provides the customer with more flexibility in payment options for an one time purchase with flexible payment schedule, thereby improving the manner in which business can be conducted by the merchant.

Unlike the traditional customer's bank sponsored electronic bill payment systems, the electronic check transaction processing system 140 described herein is part of an independent entity from both banks associated with the merchant and its customer —for example, the check acceptance service. Furthermore, electronic check transaction processing system 140 is geared towards merchants as subscribers, and the merchants' customers do not need to enroll or subscribe to the check acceptance service. One embodiment of the electronic check transaction processing system 140 comprises a mechanism configured to properly notify the customers that their check transaction is being electronic processed. Such flexibility allows a wide range of possible electronic check transactions to be carried out between the merchants and their customers.

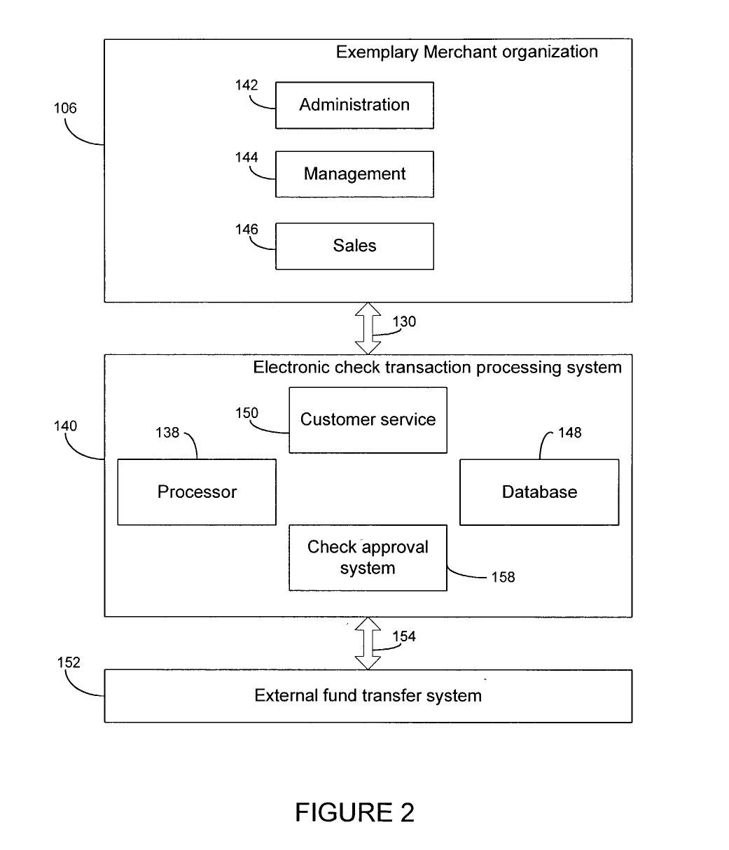

FIG. 2 illustrates a block diagram of one embodiment of the electronic check transaction processing system 140 and its interaction with the merchant 106 and an external fund transfer system 152. The processing system 140 comprises a processor that performs various electronic check transaction processes described below in greater detail. The processing system may further include, but is not limited to, a database 148, a customer service 150, and a check approval system 158 whose various functions are also described below.

In general, it will be appreciated that the processors comprise, by way of example, computers, program logic, or other substrate configurations representing data and instructions, which operate as described herein. In other embodiments, the processors can comprise controller circuitry, processor circuitry, processors, general purpose single-chip or multi-chip microprocessors, digital signal processors, embedded microprocessors, microcontrollers and the like.

Furthermore, it will be appreciated that in one embodiment, the program logic may advantageously be implemented as one or more components. The components may advantageously be configured to execute on one or more processors. The components include, but are not limited to, software or hardware components, modules such as software modules, object-oriented software components, class components and task components, processes methods, functions, attributes, procedures, subroutines, segments of program code, drivers, firmware, microcode, circuitry, data, databases, data structures, tables, arrays, and variables.

The aforementioned embodiment of the processing system 140 allows various types of interactions associated with the electronic check commerce with the merchant 106 that may comprise various entities having different levels of authority. For example, the merchant 106 is depicted as having an administration 142, a management 144, and a sales department 146. The electronic check commerce processing system 140 allows these exemplary entities to perform various electronic commerce activities.

In one aspect, the electronic commerce activity comprises effecting a payment agreement between the customer and the merchant. For example, the customer and the merchant may agree to an arrangement where several payments are to be made at agreed upon dates. The processing system 140, in a manner described below, allows such agreement to be made electronically. Furthermore, the processing system 140 includes, or has access to, the check approval system 158. In one embodiment, the check approval system 158 is configured to handle electronic check transactions, and may be one of the check approval systems disclosed in copending applications such as but not limited to U.S. patent application Ser. No. 10/041955 filed Jan. 7, 2002, titled “Systems and Methods for Selective Use of Databases to Predict Financial Risk”, and U.S. patent application Ser. No. 10/041765 filed Jan. 7, 2002, titled “Systems and Methods for Selective Use of Risk Models to Predict Financial Risk”, which are hereby incorporated by reference in their entirety.

As shown in FIG. 2, the processing system 140 interacts with an external fund transfer system 152 via an interaction 154 to process the payments at the agreed upon dates. In one embodiment, the external fund transfer system 152 comprises one or more of the fund transfer mechanisms described above in reference to FIG. 1.

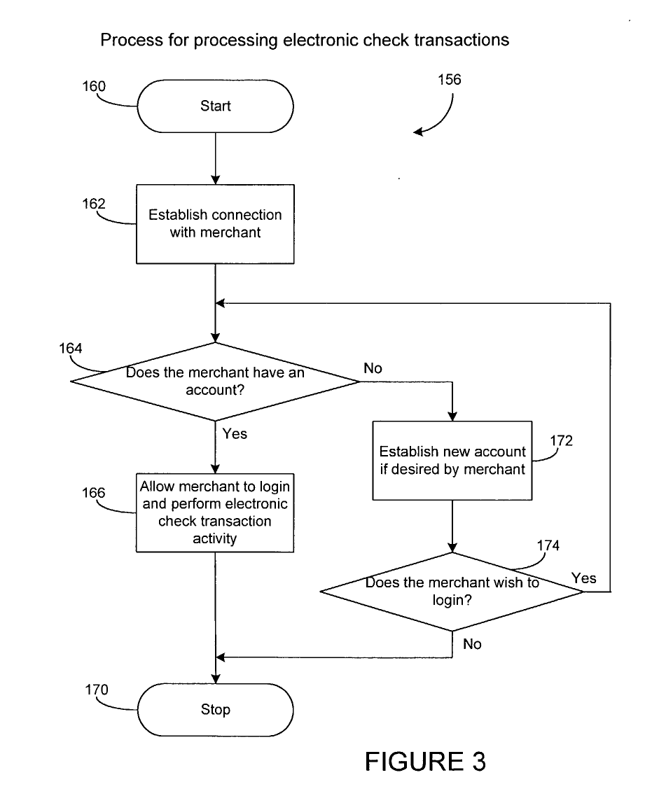

FIG. 3 illustrates a process 156 for processing electronic check transactions between the merchant and its customer. The generalized process 156 begins at a start state 160, and in state 162, a connection is established with the merchant. Preferably, the connection is formed by secure means through a readily accessible public network such as an Internet. Also, the merchant interacts with the processing system via a computer that is configured to be Internet compatible.

In a decision state 164 that follows, the process determines whether the merchant has an established account with the check acceptance service. If the answer is “yes”, the merchant is allowed to login to the processing system and perform one or more electronic check transaction activities in state 166. Upon completion of the one or more activities in state 166, the process ends at a stop state 170.

If the answer in the decision state 164 is “no”, the processing system, in state 172, establishes a new account if desired by the merchant. In a decision state 174 that follows, the process determines whether the merchant wishes to perform any electronic commerce activity under the newly created account. If the answer is “yes”, the process is directed to the decision state 164 described above. If the answer is “no”, the process ends at the stop state 170.

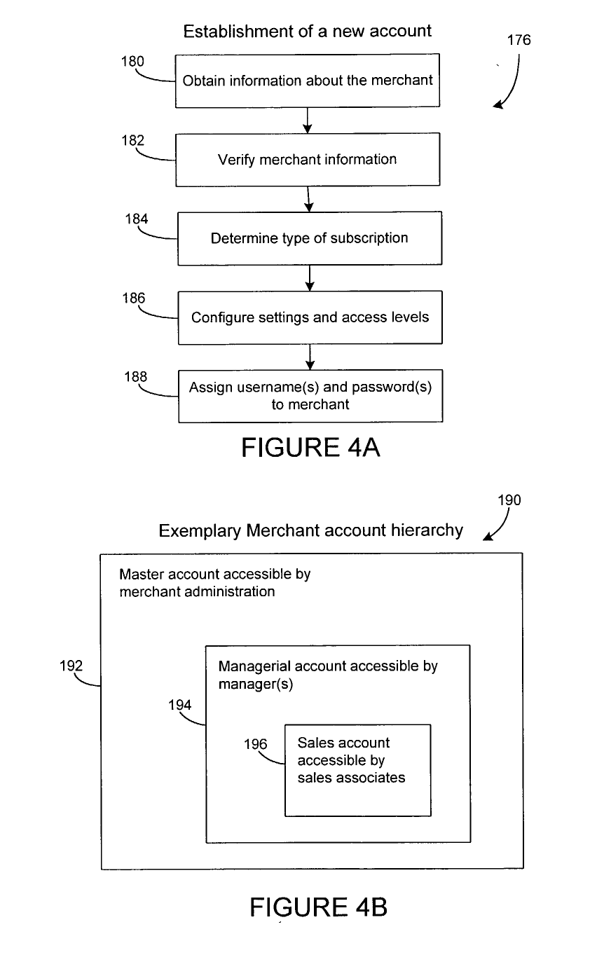

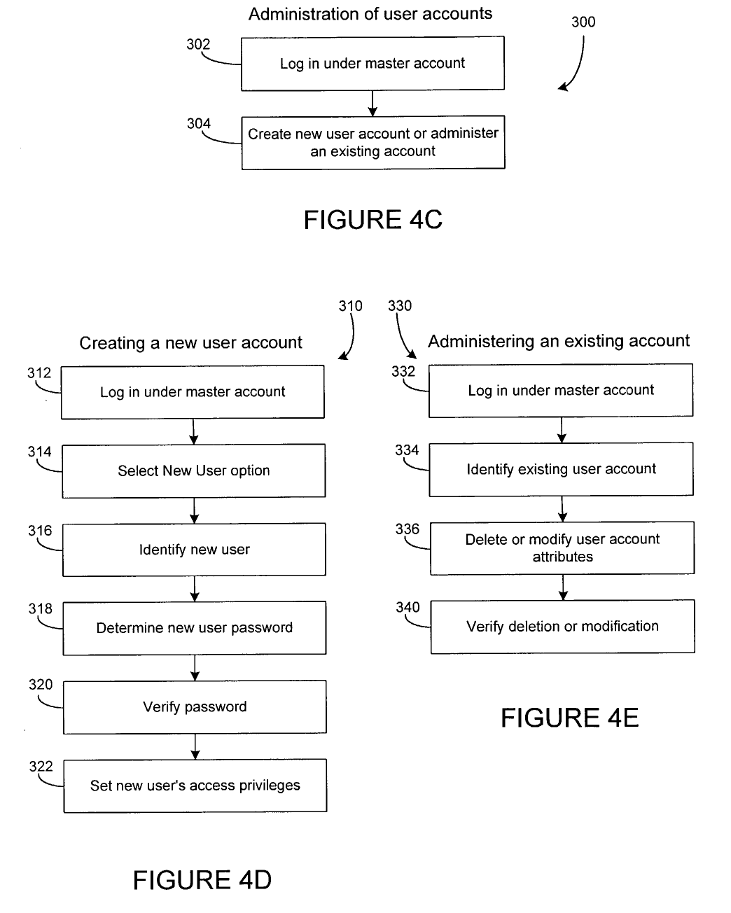

FIG. 4A illustrates a process 176 that may be implemented to establish a new account. The process 176 may occur at state 172 described above in reference to FIG. 3. In one implementation, the process 176 may be performed by the customer service department 150 (FIG. 2) in communication with the merchant 106, and also with access to the electronic check transaction processing system 140 and the database 148. In state 180, information about the merchant is obtained. The information includes, by way of example, the merchant's bank information and the merchant's desired access hierarchy that is described below in greater detail. In state 182 that follows, some of the obtained information may be verified. In state 184, the process 176 determines the type of subscription desired by the merchant. The different types of subscription may involve varying levels of transaction related risks to be assumed by the merchant and/or the check acceptance service. In state 186 that follows, settings and access hierarchy specific to the merchant are configured, and in state 188 that follows, username(s) are assigned and corresponding password(s) are established.

FIG. 4B illustrates an exemplary merchant account access hierarchy 190 that may be set up, for example, in state 186 of the process 176 described above in reference to FIG. 4A. A master account 192 encompasses substantially all aspects of the account assigned to the merchant, and is able to perform substantially all associated activities. In one implementation, the master account 192 is accessible by member(s) of administration of the merchant establishment. A user accessing the electronic check transaction processing system through the master account can, for example, also can add, terminate or edit additional users within their organization to gain access to the system in a manner described below.

A managerial account 194 is depicted as being a functional subset of the master account 192, and is intended to be accessed by manager(s) of the merchant establishment. The scope of activities that the managerial account 194 is permitted to perform is less than that of the master account 192. Although only one managerial account 194 is illustrated, it will be appreciated that more than one such account may be implemented without departing from the spirit of the invention.

A sales account 196 is depicted as being a functional subset of the managerial account 194. In one embodiment, the sales account 196 is configured to access the electronic check transaction processing system on a routine basis through devices such as, but not limited to, a computer terminal or a point-of-sales device. A routine user of the sales account may include, but is not limited to, a sales associate, a clerk, or anyone authorized under the managerial or the administrative accounts described above. The scope of activities that the sales account 196 is permitted to perform is less than that of the managerial account 194. Although only one sales account 196 is illustrated, it will be appreciated that more than one such account may be implemented without departing from the spirit of the invention. An exemplary electronic check commerce activities performed by the foregoing account types are described below in greater detail.

In one embodiment of the account hierarchy described above in reference to FIG. 4B, each of the three exemplary access levels may comprise additional sub-levels of allowed activities. For example, the master account may have a plurality of allowed functions, and a given user authorized for master account access may be allowed to perform some of the plurality of allowed functions. Another user under the master account may be allowed to perform different set of functions. Thus the access hierarchy structure provides flexibility to match the needs of different merchants.

FIGS. 4C-E illustrate how the various user accounts of the aforementioned hierarchy can be administered. In one embodiment, the administration of the user accounts is performed by an authorized user logged in under the master account. As illustrated in a generalized user account administration process 300, the authorized user logs in under the master account in step 302, and in step 304 that follows, the authorized user performs one or more administrative functions that include creation of a new user account and modification of an existing account.

A process 310 for creating a new user account, which is one possible administrative function of the step 304 in the generalized process 300 described above, is illustrated in FIG. 4D. The authorized user logs in under the master account in step 312, and in step 314 that follows, the authorized user selects an option that allows creation of the new user account. In step 316, the identity of a new user is entered into the system. In one embodiment, the identity of the new user comprises the new user's first and last names. In step 318 that follows, the new user's password is determined. In one embodiment, the new user is allowed to choose and enter the password. Alternatively, the process assigns a random password to the new user such that new user can log in and change the password at a later time. In step 320, the password is verified. In one embodiment, the new user or the authorized user is prompted to re-enter the password determined in the previous step 318. In step 322 that follows, the authorized user sets the new user's access privileges. In one embodiment, the new user may be assigned access privileges associated with access level lower than or equal to that of the authorized user, namely the master account level. Once the access level is set, the new user may be assigned specific allowed functions within that access level.

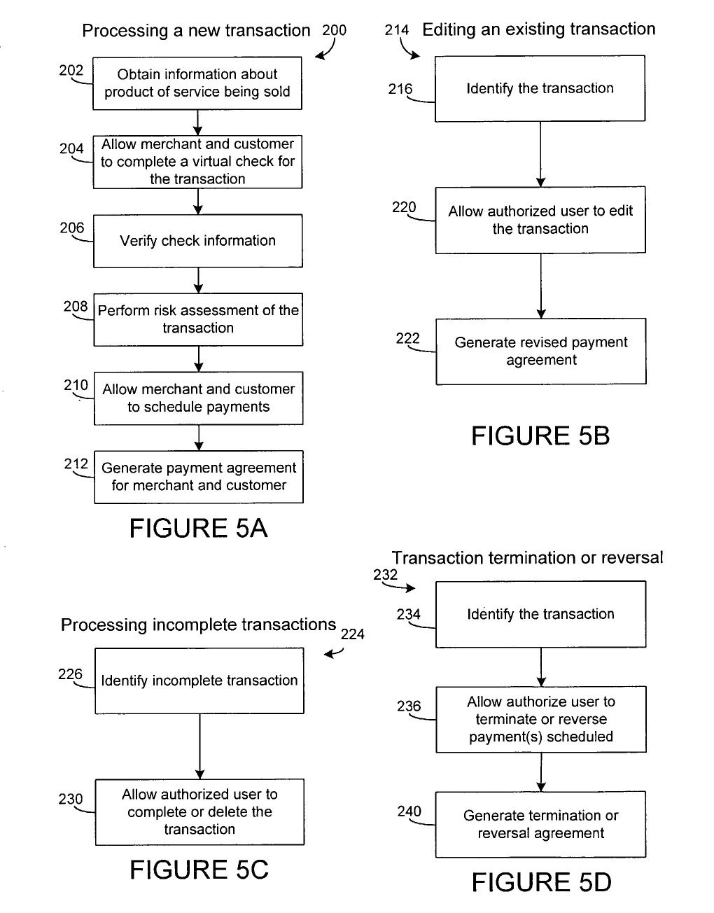

The new user account created in the aforementioned manner is now an existing user account. FIG. 4E illustrates a process 330 for administering an existing user account, which is one possible administrative function of the step 304 in the generalized process 300 described above. The authorized user logs in under the master account in step 332, and in step 334 that follows, an existing user account is identified. In one embodiment, the process 330 displays a listing of existing user accounts, wherein the listing can be sorted in a number of ways such as by last name alphabetically. Other listing features, such as selected alphabetical listing, for example, may be utilized. Once the existing user account is identified in the foregoing manner, that account may be administered to in step 336. Administering the account comprises deleting the account or modifying the account attributes. The account may be deleted, for example, if an employee associated with the selected existing user account is no longer employed by the merchant. Modifying the account attributes, for example, may comprise assigning different access privileges. In step 340 that follows, the process prompts the authorized user to verify the deletion or modification of the existing user account. FIGS. 4A-B described above relate to an one-time setup activity for a subscribing merchant. FIGS. 5A-D now illustrate some of the possible routine electronic check commerce activities. Such activities may occur, for example, in state 166 of the process described above in reference to FIG. 3. The transactional activities described in reference to FIGS. 5A-D are general in nature; specific example of one possible transaction is described below in greater detail.

FIG. 5A illustrates a process 200 that processes a new transaction. The process 200 begins in state 202 wherein the electronic check transaction processing system obtains information about a product or a service being sold. In one embodiment, the product information is entered into a computer or an equivalent access method by an authorized user, which could be a master, managerial or sales associate describe above in reference to FIG. 4B. Alternatively, the product information is integrated into the electronic check transaction processing system in a manner described below. In state 204 that follows, the process provides a means that allows the merchant and the customer to enter information associated with the check. The means provided by the process may include, but is not limited to, a virtual check or a form displayed on the screen of the point-of-sales computer, or an external device such as a MICR (magnetic ink character recognition) reader and/or imager configured to capture check information, thereby allowing the merchant and the customer to enter the check information. In state 206 that follows, some of the check information entered in the foregoing manner is verified. In one implementation of the process, the process prompts for the customer's check MICR number, and prompts the sales associate to re-enter the number as a verification. In state 208, the process 200 performs a risk assessment of the transaction based on the transaction information of the total amount authorized. If the check amount is not authorized then the transaction is terminated. If the check is authorized the process proceed to the next step. The risk assessment may be in the form of the systems and methods described in the above incorporated references U.S. patent application Ser. Nos. 10/041955 and 10/041765. In state 210 that follows, the process 200 allows formation of a schedule of payments that is agreeable to both the customer and the merchant. In state 212 that follows, the electronic check transaction processing system generates a printable payment agreement document that can be printed by the sales associate and signed by the customer. In one implementation, a voided customer's check is attached to the signed agreement document, and the document is kept in a file.

In one embodiment, the electronic check commerce processing system saves the new transaction at various stages of the process 200. The transaction may be assigned a transaction ID number and saved in the database, thereby allowing the transaction to be retrieved at a later time. In certain circumstances, the process 200 of processing a new transaction and coming to a payment agreement may not be completed due to various reasons. For example, terms of payment agreement may not be agreeable between the customer and the merchant, and the customer may leave the merchant's establishment without completing the process 200. In other circumstances, a saved transaction, completed or not, may need to modified. Thus in order to handle such situations, the electronic check transaction processing system allows the merchant to perform various transaction-related activities.

FIG. 5B illustrates one such process 214 that allows the merchant to edit an existing transaction. The process 214 begins when an authorized user logs in and chooses the edit option and identifies the transaction in state 216 by a number of sorts, such as but not limited to the transaction ID, Merchant ID, and other variables. In state 220 that follows, the process 214 allows the transaction to be edited by the authorized user. Editing of the transaction can include, by way of example, changing the payment schedule for an agreed upon product. Editing of the transaction may also include a feature that allows the authorized user to edit unpaid portion(s) of the payment schedule. If any payment has been made already, the editing feature also may be configured to allow reversal of transaction(s) to be conducted. Once the transaction is edited, a revised payment agreement is generated in state 222, printed by the merchant, and signed by the customer in a manner similar to that described above in reference to FIG. 5A. In one embodiment, the editing feature allows multiple editing wherein the total number of multiple edits and/or when they can be edited depend on factors such as application/market engaged by the merchant.

FIG. 5C illustrates another process 224 that allows the merchant to retrieve and complete an incomplete transaction. The process 224 begins in state 226 when an authorized user logs in and retrieves the existing transaction by a number of sorts, such as but not limited to, the transaction ID, Merchant ID, and other variables. In state 230 that follows, the process 224 allows the transaction to be completed in a manner described above in reference to FIG. 5A. Alternatively, if the transaction is not to be pursued, it can be deleted from the system.

FIG. 5D illustrates a process 232 that allows an existing transaction to be terminated or reversed. Such a need may arise, for example, when the customer returns a purchased item for a refund. The process begins in state 234 when an authorized user logs in and identifies the transaction. In state 236 that follows, the process 232 allows the authorized user to terminate unpaid portion(s) of the payment schedule, and if any payment has been made already, reverse those payments from the merchant to the customer. In state 240 that follows, a termination or reversal agreement is generated, printed by the merchant, and signed by the customer.

In one embodiment, the electronic check transaction processing system and the exemplary merchant access hierarchy are configured such that the new transaction process 200 of FIG. 5A can be performed by any user at the various levels of the merchant's account, including the sales account. Other types of activities relating to the existing transaction are permitted to be performed by the managerial account or the administrative account.

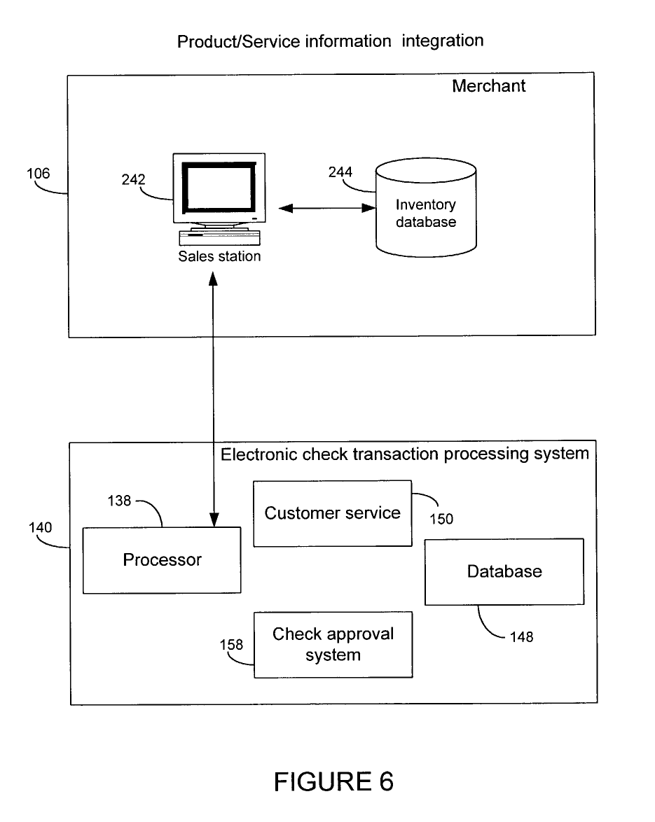

As referred to above in reference to FIG. 5A, information about the product (or the service) is obtained during the process 200. FIG. 6 illustrates one embodiment where the information about the product is integrated such that the electronic check transaction processing system 140 is able to retrieve details about the product from the merchant's inventory database 244 via a computer 242 where the sale is taking place. When the sales associate enters an identifier, such as a stock number, at the beginning of the process 200, the associated information is retrieved from the inventory database 244 and transferred to the processing system 140. The processing system 140 then may incorporate the product information when generating the payment agreement document. In one embodiment, a software is provided by the check acceptance service 110 to the merchant 106 during the initial account establishment process such as that described above in reference to FIGS. 3 and 4.

As described above, FIGS. 3-6 relate to the various types of interactions between the check acceptance service, and in particular the electronic check commerce processing system, with the merchant. Another aspect of the electronic check commerce processing system relates to effecting the transfer of funds from the customer's checking account to the merchant's checking account. As previously described, such transfer of funds is performed by the external fund transfer system 152.

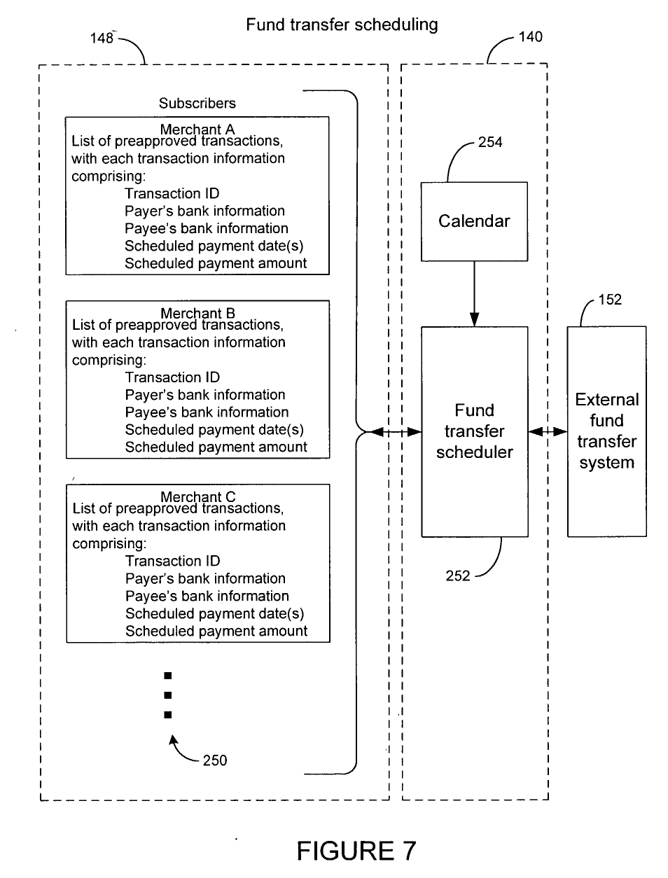

As illustrated in FIG. 7, the check acceptance service comprises a plurality of subscribers 250. In one embodiment, the information about the subscribers and their transactions are stored in the database 148. Associated with each subscriber (merchant) is a list of transactions, with each transaction comprising information such as the transaction ID, payer's (customer's) bank information, payee's (merchant's) bank information, scheduled payment date(s), and the payment amount(s).

In one embodiment, the electronic check transaction processing system 140 comprises a fund transfer scheduler 252 that integrates the plurality of transactions of the plurality of subscribers and queues the payments in a chronological order. The scheduler 252 then, facilitated by a calendar 254, sends the fund transfer instructions to the external system 152 as the payment dates are encountered.

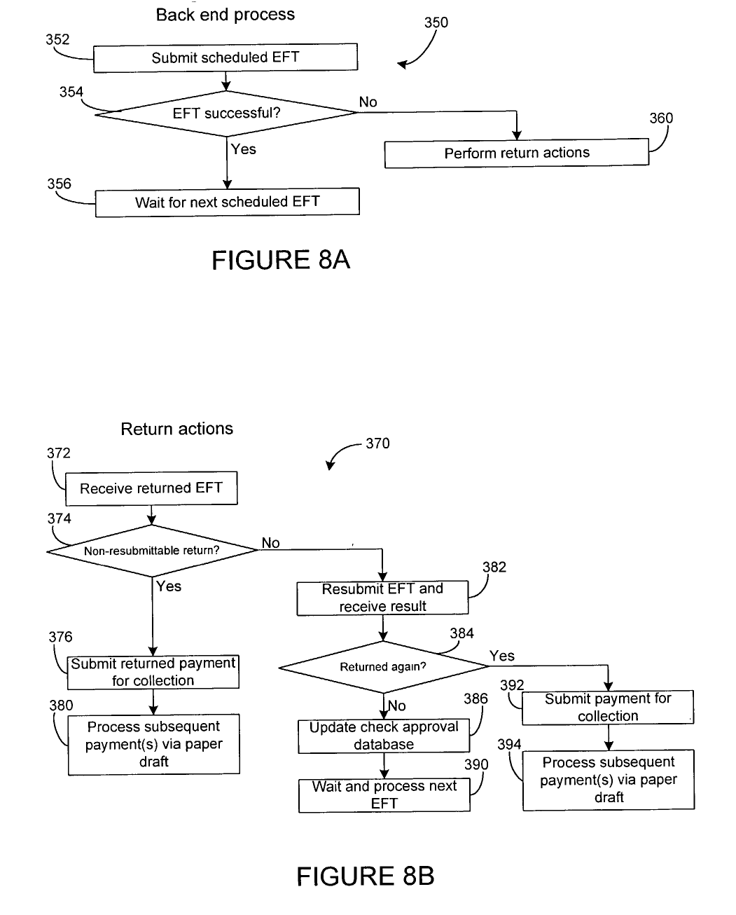

FIGS. 8A-B illustrates a back end process 350 that occurs between the processing system 140 and the external fund transfer system 152 described above in reference to FIG. 7. Specifically, one aspect of the back end process relates to how the processing system handles scheduled payment(s) that get returned from the external fund transfer system 152 for various reasons.

FIG. 8A illustrates a generalized back end process 350, wherein a scheduled electronic fund transfer (EFT) is submitted to the external system 152 in step 352. If the submitted EFT is successful as determined in state 354, the process awaits for the next scheduled EFT of the transaction. If the submitted EFT is not successful, the process 350 performs a return action in step 360.

FIG. 8B illustrates one possible process 370 for performing various return actions. In step 372, the process receives a returned EFT along with a return reason code. The process determines in state 374 whether the return is a non-resubmittable return. The non-resubmittable return may be due to circumstances such as a closed account. An administrative return is another example of the non-resubmittable return, and results when the EFT cannot be processed electronically by the external system 152 for reasons such as unrecognizable MICR. Typically, administrative returns occur on first of the scheduled payments but it can also occur in any of the scheduled payments (i.e., if a bank merger occurs and the MICR is no longer recognizable). If the return is a non-resubmittable return, the process submits, in step 376, the returned payment for collection. The collection may include resubmission of a paper draft to an originating depository financial institution (ODFI) associated with the processing system. The ODFI then further processes the paper draft. In step 380 that follows, the process processes the subsequent scheduled payment(s) via paper draft.

If the return in state 374 is not a non-resubmittable return, the process 370 resubmits the EFT and receives the result in step 382 based on return reason codes. The process then determines in step 384 whether the EFT has returned for a second time. If “yea”, the returned EFT payment is submitted for collection in step 392, and in step 394 that follows, the process processes any subsequent payment(s) via paper draft. If the answer in state 384 is “no”, the second attempt in the submitted EFT has been successful, and in step 386, a check approval database may be updated to reflect the initial return for the customer. In step 390 that follows, the process awaits and processes the next scheduled EFT. Each of the subsequent EFT may then be subject to return actions similar to the aforementioned processes 350 and 370.

In one embodiment, the electronic check processing system assumes substantially all of the responsibility of handling the unsuccessful EFTs as described above. In such an arrangement, the processing system guarantees the transaction set up by the merchant, and the merchant does not need to be aware of these returns. Alternatively, the merchant may opt for a non-guaranteed subscription at a lower fee, in which case the merchant bears at least some of the responsibility of handling the returned payments.

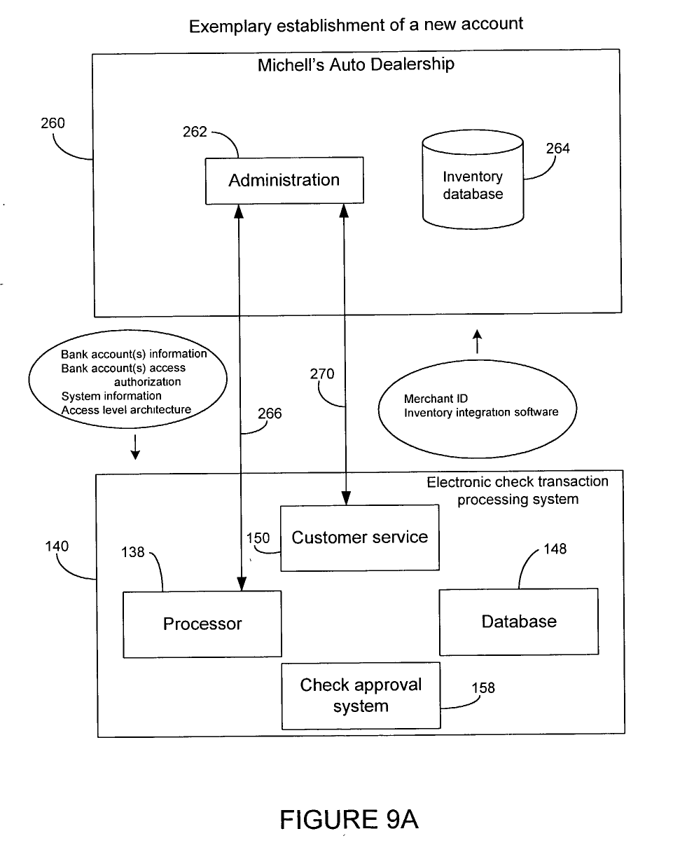

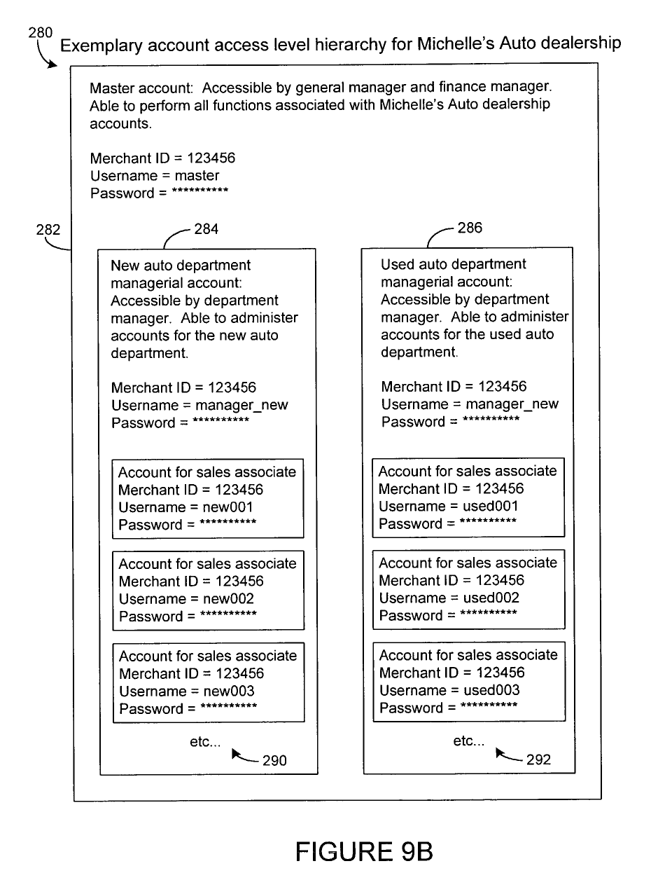

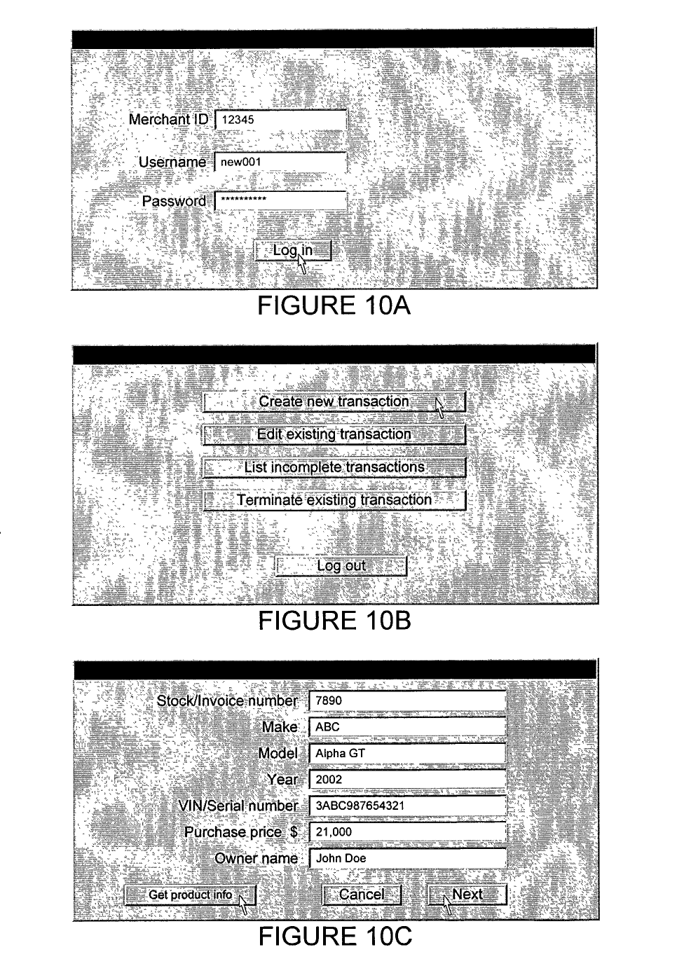

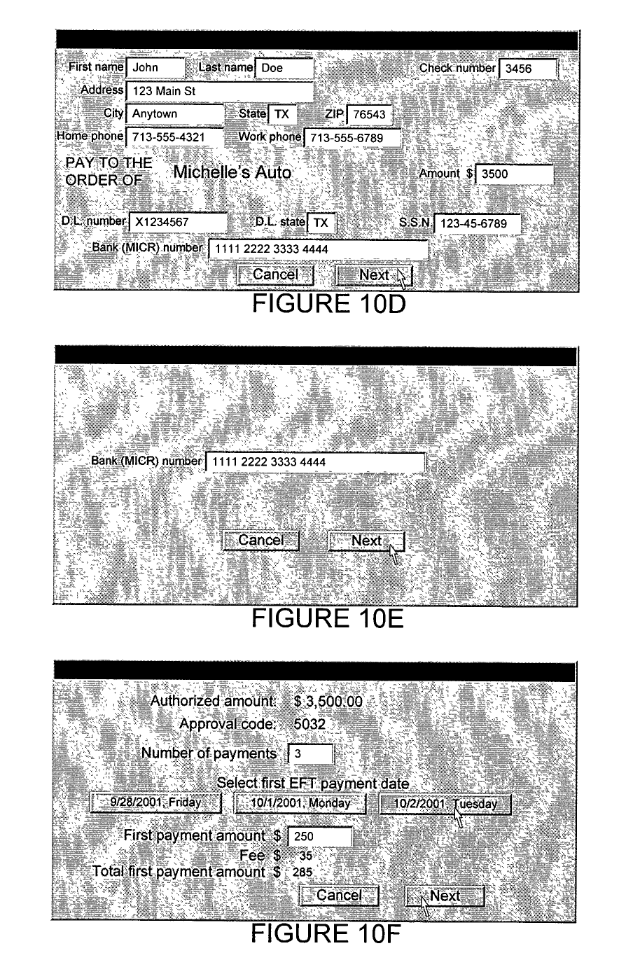

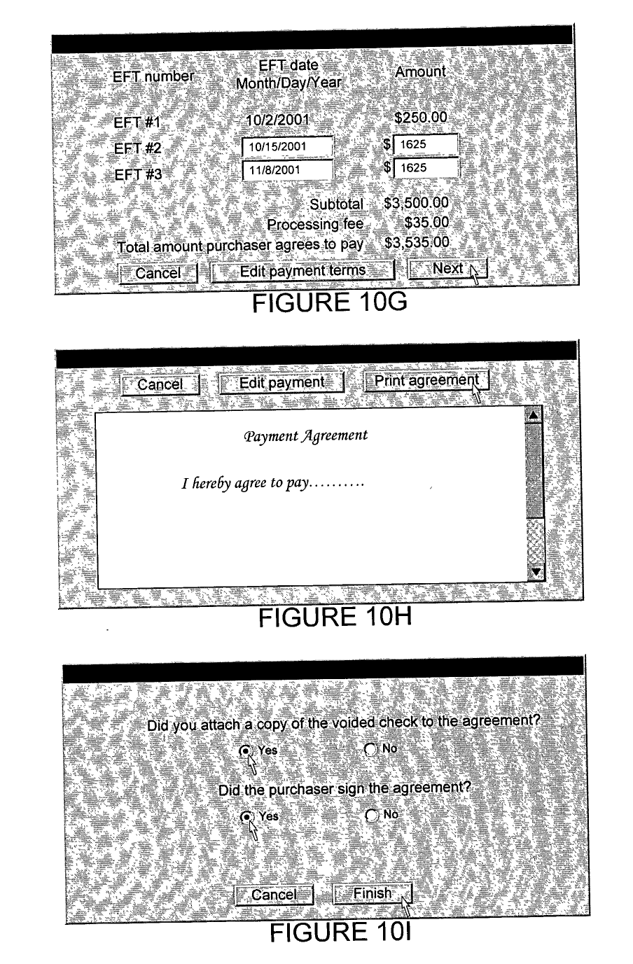

FIGS. 9-10 now illustrate a specific example interaction between the electronic check transaction processing system and an exemplary merchant, an automobile dealer 260. The automobile dealer 260 has determined that by allowing the customers to pay their down payments in several installments, the customers are more likely to purchase the automobiles. In order to automate such installments of payments, the dealer 260 subscribes (or upgrades its subscription) to the check acceptance service 110. Furthermore, because the payments are pre-approved by the check acceptance service, the dealer 260 receives the payments with reduced risks depending on the type of subscription.

To establish a new account, an administration 262 of the dealership 260 connects to the processing system 140 through an Internet-based connection 266 and/or a telephone connection 270. The administration 262 provides the processing system 140 with particulars such as dealer's bank account(s) information, bank account(s) access authorization, dealer's computer system information, and desired access level architecture. The processing system 140 in return provides the dealer 260 with particulars such as assigned merchant ID and an inventory integration software that allows dealer's inventory database 264 to be integrated into the processing system. In the exemplary interaction of the electronic check transaction processing system with the exemplary merchant described below, it will be understood that variables such as usernames and IDs are exemplary, and in now way intended to limit the scope of the methods and systems described herein.

By establishing the new account in the foregoing exemplary manner, the dealership is able to set up an exemplary access hierarchy 280 illustrated in FIG. 9B. The dealership is assigned a merchant ID of 12345, and the access hierarchy 280 comprises a master account 282 with an assigned username of master, and a password that is determined by the administration. The exemplary master account, for example, is intended to be accessible by the general manager and the finance manager of the dealership, and the master account is able to perform substantially all the functions associated with the dealership accounts.

The exemplary access hierarchy 280 further comprises two managerial level accounts 284 and 286, for a new auto department and a used auto department, respectively. The two managerial accounts 284, 286 are under the authority of, and may be administered by the master account 182. The new auto department managerial account 284 is assigned a username of manager—new and a password determined by the administration. The account 284 is intended to be accessible by department manager(s), and the account 284 is able to perform sales activities as well as administer a plurality of sales accounts 290 that are within its authority. In one embodiment, each new auto department sales associate is assigned his or her own sales account with a unique username and a password that can be chosen. Each of the sales account 290 is intended to be accessible by its assigned sales associate, and transactions accessible are associated with that particular associate. In a similar manner, the used auto department managerial account 286 has under its authority a plurality of sales accounts 292 whose functions and access levels are similar to their counterparts in the new auto department.

Once an account is established for the exemplary auto dealership in the foregoing manner, an exemplary transaction may be performed in a manner described below in reference to FIGS. 10A-I that depict various interactive computer windows. The exemplary transaction is performed by a new auto department sales associate, and the transaction comprises an electronic check payment agreement for a down payment on a purchase of a new vehicle. The purchaser has determined that splitting the down payment into several payments is a desirable option. In each illustration of the computer window, one or more cursor pointers indicate the option(s) selected by the sales associate. Preferably, the transaction is performed via a secure Internet connection.

In a login window of FIG. 10A, a secure Internet connection has been established between the auto dealership and the check acceptance service. Proper merchant ID, username, and password are entered by the sales associate, and the sales associate is logged in. In a main menu window of FIG. 10B, a plurality of options are presented to the sales associate. Such options can include creating a new transaction, editing an existing transaction, listing of incomplete transactions, and terminating (or reversing) an existing transaction. As seen in FIG. 10B, the new transaction option is selected by the sales associate. As previously described, some of these activities, such as terminating or reversing the existing transaction, may require approval from one of the managers. Furthermore, it will be appreciated that the main menu may comprise other options such as administrative functions. In one embodiment, such options are disabled from being selected when logged in as a sales associate.

A product information window of FIG. 10C requests for information about the vehicle being sold. In one embodiment, a stock number for the vehicle is entered, and the “get product info” option is selected. As previously described, the electronic check commerce processing system may be interconnected to the dealer's inventory database. As such, vehicle-specific information is retrieved and displayed on the window. Alternatively, the information may be entered manually by the sales associate. In one implementation, the purchase price of the vehicle and the purchaser's name are entered by the sales associate, and the transaction continues by selecting the “next” option.

FIG. 10D illustrates a virtual check that is displayed in the transaction window. Various edit boxes allow information about the purchaser and the purchaser's checking account to be entered. In one embodiment, information such as name, address, and MICR need to be substantially same as that found on the actual check owned by the purchaser. Other information such as phone numbers, driver license information, and social security number are entered into the virtual check. In one embodiment, a check number is entered into the virtual check, and the entered number is the same as the number printed on the check that is to be voided and attached to an agreement in a manner described below. It will appreciated that the virtual check is only one possible example of how the check information can be transferred to the electronic check transaction processing system. In other applications, other methods, such as but not limited to a form based screen, MICR reader, or a check image capturing system, may be implemented without departing from the spirit of the invention. In the exemplary virtual check, the purchaser wishes to pay a total of $3500 as down payment on the new vehicle. The total of $3500 is to be paid in several installments in a manner described below. The transaction continues by selecting the “next” option.

In one embodiment, the transaction prompts the sales associate to confirm the MICR number as illustrated in FIG. 10E. Once the MICR is entered into the edit box, the transaction continues by selecting the “next” option.

As illustrated in FIG. 10F, the processing system has approved the authorized amount of $3500. The approval of the total amount can be achieved by the check approval system described above. In one embodiment, the processing system utilizes a check approval process in use by the check acceptance service in order to approve the transaction. Such approval may depend on the check writing history of the purchaser, and other factors that affect the risk associated with the transaction.

As further illustrated in FIG. 10F, the purchaser wishes to make a total of three payments, with the first payment being in the amount of $250. In one embodiment, the processing system displays several payment dates for the first payment, from which one can be selected. The several allowed choices for the first payment may follow the dealership's policy regarding acceptance of down payments. For example, the dates allowed are within three to five business days from the date of purchase of the vehicle. As indicated in FIG. 10F, the purchaser wishes to have the first payment to occur as late as possible; thus the last date from the allowed dates is selected. The window also informs the purchaser of a transaction fee to be paid by the purchaser to the check acceptance service. A total first payment is displayed. The transaction fee may be processed separately and independently from the scheduled payment. In one embodiment, the transaction fee is processed when the first scheduled payment is processed. The transaction continues by selecting the “next” option.

FIG. 10G illustrates a window that allows the purchaser and the sales associate to select second and third payments of the exemplary three payment agreement. The purchaser agrees to pay $1625 as the second payment approximately two weeks after the first payment, and another $1625 as the third payment approximately three weeks thereafter. In one embodiment, the manner in which the payments are divided, as well as how far the payments can be spread out in time, are constrained by the policy set by the dealership. For example, the dealer may require that the series of payments be made within 30 days from the date of purchase. In one embodiment, the payment terms can be edited at this point of the transaction. The transaction continues by selecting the “next” option.

FIG. 10H illustrates a window that displays a printable payment agreement. The agreement includes information about the transaction gathered in the foregoing manner. In one embodiment, the agreement is printed, signed and dated by the purchaser, and the voided check is attached to the agreement. The signed agreement is then filed at the dealership.

FIG. 10I illustrates a verification window that verifies whether the voided check is attached to the agreement and whether the purchaser has signed the agreement. The sales associates selects “yes” to both questions, and finishes the transaction by selecting the “finish” option. In one embodiment, a printable transaction confirmation window is displayed thereafter. Furthermore, once the transaction confirmation is printed, the processing system may provide the sales associate with an option of logging out or returning to the main menu described above.

Although various embodiments and implementations of the invention have shown, described and pointed out the fundamental novel features of the invention, it will be understood that various omissions, substitutions and changes in the form of the detail of the systems and methods illustrated may be made by those skilled in the art without departing from the spirit of the invention. Consequently, the scope of the invention should not be limited to the foregoing description, but should be defined by the appending claims.

What is claimed is:

1. A system for processing an electronic check transaction between a merchant and its customer, the system comprising:
a first connection that allows the merchant to connect to the system to arrange the electronic check transaction;
a second connection that connects the system to an external fund transfer system thereby allowing funds to be transferred between the banks associated with the merchant and the customer wherein the system is independent from the banks;
a risk assessment system that evaluates risks associated with the transaction and assigns a risk score; and
a processor that allows, based on the risk score, the merchant and a customer to electronically arrange the electronic check transaction via the first connection wherein the electronic check transaction comprises one or more predetermined number of electronic check payments at selected dates within a predetermined time limit, and wherein the processor executes the payments at the selected dates via the second connection.

2. The system of claim 1, further comprising a merchant computer that connects to the processing system via the first connection.

3. The system of claim 2, further comprising a merchant inventory database that interacts with the merchant computer and the processing system thereby allowing easier processing of product or service information by the processor.

4. The system of claim 2, wherein the first connection comprises a secure Internet connection.

5. The system of claim 2, wherein the processor saves a transaction thereby allowing the merchant to modify or reverse the transaction at a later time.

6. The system of claim 2, wherein the processor allows the merchant to have a hierarchy of authorized access to the system.

7. The system of claim 6, wherein the hierarchy of authorized access comprises a master account that is authorized to perform a first scope of functions associated with the merchant.

8. The system of claim 7, wherein the hierarchy of authorized access further comprises one or more sales accounts authorized to perform a second scope of functions that is less than the first scope of functions.

9. The system of claim 8, wherein the first scope of functions comprises substantially all of allowable functions associated with the merchant.

10. The system of claim 9, wherein the first scope of functions includes administration of the accounts wherein administration includes creation of new account and modification of existing accounts.

11. The system of claim 9, wherein the second scope of functions comprises creating a new transaction.

12. The system of claim 1, wherein the second connection is configured to perform back end processes including a process for handling returned electronic payments.

13. The system of claim 12, wherein the process for handling the returns comprises processing the returned payment and any subsequent scheduled payments by paper draft if the return was due to an electronically non-resubmittable reason.

14. The system of claim 13, wherein the process for handling the returns further comprises submitting the payment for a second time if the return was due to reasons other than the non-resubmittable reason and wherein the payment is processed by paper draft if the resubmitted payment is returned again.

15. A method of processing an electronic check transaction between a merchant and its customer, the method comprising:
establishing a first connection with the merchant and receiving details about the electronic check transaction;
determining a risk associated with the electronic check transaction;
allowing, based on the risk, the merchant and the customer to electronically arrange the electronic check transaction that comprises one or more predetermined number of electronic check payments at selected dates within a predetermined time limit; and
executing the arranged electronic check payments at the selected dates such that funds are transferred between the external banks associated the merchant and the customer.

16. The method of claim 15, wherein establishing the first connection comprises forming a secure Internet connection with a merchant's computer.

17. The method of claim 16, further comprising accessing merchant's inventory database to facilitate easier arrangement of the electronic check transaction.

18. The method of claim 16, wherein allowing the merchant and the customer to arrange the electronic check transaction includes saving the transaction thereby allowing the merchant to modify or reverse the transaction at a later time.

19. The method of claim 16, wherein establishing the first connection with the merchant comprises establishing a hierarchy of authorized access for one or more users of the merchant.

20. The method of claim 19, wherein establishing the first connection with the merchant further comprises allowing a user to log in with designated authorized access wherein the designated authorized access allows the user to perform selected transaction related operations.

21. The method of claim 15, wherein executing the arranged electronic check payments includes processing returned payments.

22. The method of claim 21, wherein processing returned payments comprises routing the returned payment and any subsequent scheduled payments for collection by paper draft if the return was due to an electronically non-resubmittable reason.

23. The method of claim 22, wherein processing returned payments further comprises submitting the payment electronically for a second time if the return was due to reasons other than the non-resubmittable reason and wherein the payment is processed by paper draft for collection if the resubmitted payment is returned again.

24. An apparatus for processing an electronic check transaction between a merchant and its customer, comprising:
a first means for establishing a connection with the merchant thereby allowing the merchant and the customer to request an electronic check transaction between the merchant and the customer wherein the transaction comprises one or more predetermined number of payments at selected dates that are within a predetermined time limit; and
a second means for approving and executing the electronic check transaction between the banks associated with the merchant and the customer wherein the apparatus is independent from the banks.

25. The apparatus of claim 24, wherein the first means for establishing the connection comprises establishing secure Internet connection with merchant's computer.

26. The apparatus of claim 25, wherein the first means further comprises accessing merchant's inventory database to facilitate integration of product information into the electronic check transaction.

27. The apparatus of claim 24, wherein the first means for establishing the connection includes a hierarchy of authorized access for different users at a given merchant establishment wherein the hierarchy determines the scope of allowed transaction related functions to be performed.

28. The apparatus of claim 27, wherein users of a high hierarchy is allowed to administer the accounts associated with users of hierarchy lower than or equal to the high hierarchy.

29. The apparatus of claim 24, wherein the second means for approving and executing the electronic check transaction comprises a check approval system that evaluates risks associated with the transaction and either approves or declines the transaction.

30. The apparatus of claim 29, wherein the second means further comprises a connection to an external fund transfer system wherein the external fund transfer system is instructed to carry out the pre-approved scheduled payments at the selected dates.

31. The apparatus of claim 30, wherein the second means further comprises a process for handling returned payments.

32. The apparatus of claim 31, wherein the process for handling returned payments comprises routing the returned payment and any subsequent scheduled payments for collection by paper draft if the return was due to an electronically non-resubmittable reason.

33. The apparatus of claim 32, wherein the process for handling returned payments further comprises submitting the payment electronically for a second time if the return was due to reasons other than the non-resubmittable reason and wherein the payment is processed by paper draft for collection if the resubmitted payment is returned again.

34. A system for processing a proffered electronic check transaction between a merchant and a customer wherein the proffered electronic check transaction comprises a plurality of separate promissory payments made from the customer's bank account to the merchant's bank account over a pre-selected period of time, the system comprising:
at least one point of sale device located in at least one merchant location, wherein the at least one point of sale device transmits transaction information identifying the customer, the merchant, a proffered payment and a proffered payment schedule;
a risk assessment agency that receives the transaction information and performs a risk assessment of the proffered payment and the proffered payment schedule to assess the likelihood that the customer will be able to provide the proffered payments at the proffered payment schedule;
a bank transaction component associated with the risk assessment agency, wherein the bank transaction component in response to the risk assessment agency determining that the customer has an acceptable risk level and accepts the proffered payment at the proffered payment schedule, interacts with the customer's and merchant's banks so that electronic checks will be forwarded from the customer's account to the merchant's account according to the proffered payment schedule.

35. The system of claim 34, wherein the at least one point of sale device comprises a computer configured for a secure Internet connection.

36. The system of claim 35, further comprising an inventory database at the merchant location and connected to the computer so as to facilitate the transaction information.

37. The system of claim 34, wherein the proffered payment schedule comprises a total amount to be paid divided into more than one individual payments at selected dates within a specified time limit such that the payment schedule is close ended.

38. The system of claim 37, wherein the risk assessment agency performs the risk assessment based on the total amount to be paid and either approves or declines the transaction based on the total amount.

39. The system of claim 34, wherein the bank transaction component further comprises a process configured to handle returned payments.

40. The system of claim 39, wherein the process comprises routing the returned payment and any subsequent scheduled payments for collection by paper draft if the return was due to an electronically non-resubmittable reason.

41. The system of claim 40, wherein the process further comprises submitting the payment electronically for a second time if the return was due to reasons other than the non-resubmittable reason and wherein the payment is processed by paper draft for collection if the resubmitted payment is returned again.

42. A method of facilitating a purchase transaction by a customer from a merchant, wherein the customer presents the merchant with an offer to purchase or good or service with a plurality of promissory payments made according to a pre-selected schedule, the method comprising:
transmitting information to a risk assessment component which evaluates whether the customer will be able to make the plurality of promissory payments according to the pre-selected schedule;
transmitting a request from the risk assessment component to the customer's bank to establish a schedule of electronic check payments from the customer's bank account to the merchant's bank account which corresponds to the plurality of promissory payments made according to the pre-selected schedule.

43. The method of claim 42, wherein transmitting information to the risk assessment component comprises transmitting information about the customer, the merchant, and the good or service being purchased.

44. The method of claim 43, wherein transmitting information further comprises obtaining information about the good or service being purchased directly from a database at the merchant location.

45. The method of claim 44, wherein the schedule of electronic check payments comprises a total amount to be paid divided into more than one individual payments at selected dates within a specified time limit such that the payment schedule is close ended.

46. The method of claim 42, further comprising processing returned electronic check payments wherein a returned payment is processed via a paper draft if the returned payment meets a selected criteria.
